(19) United States
(12) Patent Application Publication
(10) Pub. No.: US 2014/0279498 A1
(43) Pub. Date: Sep. 18, 2014

(54) Secure Identity Element

(71) Applicant: BANK OF AMERICA CORPORATION, Charlotte, NC (US)

(72) Inventors: Hood Qaim-Maqami, Montclair, NJ (US); Rick Knafelz, Charlotte, NC (US)

(73) Assignee: Bank of America Corporation, Charlotte, NC (US)

(21) Appl. No.: 13/796,199

(22) Filed: Mar. 12, 2013

(51) Int. Cl. G06Q 20/40

(52) U.S. Cl. CPC G06Q 20/4014
USPC 705/44

(57) ABSTRACT

Methods, systems, computer-readable media, and apparatuses for utilizing a secure identity element to facilitate transactions are presented. In some embodiments, a computing device may detect a payment device. Subsequently, the computing device may cause a payment credential to be displayed on the payment device, where the payment credential includes an image of an authorized user of the computing device. Thereafter, the computing device may receive, from the payment device, a request to complete a payment transaction. Responsive to receiving user input approving the payment transaction, the computing device may cause a payment to be made to an account associated with the payment device. In some embodiments, in receiving the request to complete the payment transaction, the computing device also may receive a photo credential for an authorized user of the payment device and/or an amount to be paid in the payment transaction, which can be displayed by the computing device.

### BACKGROUND

Aspects of the disclosure relate to computer hardware and software. In particular, one or more aspects of the disclosure generally relate to computer hardware and software that can be used in providing a secure identity element and in utilizing such a secure identity element in performing various transactions, including mobile payment transactions.

Mobile devices, such as smart phones, tablet computers, and other types of mobile computing devices, are becoming more and more popular, and users of these devices are increasingly growing to demand and expect greater functionality and convenience from these devices.

Some current mobile devices now include features and functionalities that enable users to listen to music, read books, watch movies and other video content, play video games, and instant message and video conference with users of other devices. In addition, some current mobile devices also provide users with more utilitarian features and functionalities, such as enabling users to shop online, make restaurant reservations, and check financial account balances and view account statements.

Although some current mobile devices may provide some basic functionalities with respect to financial accounts (e.g., allowing a user to view account balances, check account activity), more advanced functionalities might be limited, if not entirely unavailable, because of a number of reasons, which may include security concerns related to both the physical and logical security of these mobile devices.

For example, because some mobile devices may be easily stolen or may be susceptible to being accessed and/or used by an unauthorized person, it may be difficult to provide a sufficient level of security to enable such a mobile device to be reliably used in initiating and completing a financial transaction, such as making a payment from a user's account to another person's account. Moreover, to the extent that it may be possible to secure such a mobile device, conventional and/or currently existing security measures can render the mobile device inconvenient to access, difficult to use, and unsuitable for use as a payment device.

### SUMMARY

Aspects of the disclosure provide various techniques that enable a mobile device to initiate and complete financial transactions, which may include making and receiving payments, in more secure, intuitive, convenient, and easy-to-use ways.

Certain embodiments are described that provide a payment credential, which can be displayed on, provided by, and/or otherwise used with a mobile device in initiating and completing financial transactions. Such a payment credential may, for example, include a picture of an authorized user of the mobile device. In addition, this picture can be stored by the mobile device in a software secure element and optionally synchronized with a central payment server, thereby forming a secure identity element that can be securely accessed and used in initiating and completing various financial transactions (e.g., in making payments to and receiving payments from users of other devices).

For example, a user may be able to utilize such a picture-enhanced payment credential to initiate and complete a transaction by causing the credential to be displayed on the mobile device and subsequently presenting the displayed credential to another entity (e.g., the person to be paid) or to another device (e.g., a merchant point-of-sale (POS) terminal). In some instances, this picture-enhanced payment credential may be guaranteed or otherwise backed by a financial institution that maintains one or more financial accounts linked to the payment credential, and back-end processing performed by one or more central servers operated by the financial institution may enable funds to be moved between accounts in accordance with transactions conducted using the payment credential.

By including a picture of a person who is both an authorized user of the payment credential and an authorized user of the mobile device, a payment credential that implements various aspects discussed below may provide greater security when conducting financial transactions using the credential. For instance, because the picture included in the payment credential may be a picture of a person who is authorized to use both the credential and the device, and because the picture may be displayed (along with other information associated with the payment credential, including account information) to the other party in a desired transaction, this other person (who may be an individual payee, a store clerk, a restaurant waiter, or the like) may be able to easily verify the identity of the person who is attempting to use the credential to make a payment and/or otherwise complete the desired transaction. Moreover, this picture, which may be part of the payment credential, may itself be encrypted and stored in a software secure element that is maintained on the mobile device, which may prevent the picture from being tampered with or accessed without authorization. In some instances, this picture also may be synchronized with one or more servers operated by the financial institution, and a synchronized copy of the picture may be displayed on the other party's device (e.g., the merchant's point-of-sale device) to enable verification of the user of the payment credential before the other party accepts the payment and/or otherwise completes the transaction.

In addition, certain other embodiments are described that utilize a payment credential, such as the picture-enhanced payment credential discussed above, to facilitate payment processes in which a user of a mobile device can operate the mobile device to present such a payment credential and complete a transaction.

In particular, in some of the payment processes discussed in greater detail below, a user of a mobile device may unlock a secure element on the device and may subsequently cause information associated with the payment credential (e.g., including the picture(s) of authorized user(s) of the payment credential) to be provided to a payment device (e.g., a merchant point-of-sale terminal). As introduced above, this information may, for example, enable the user of the payment device to verify the identity of the user of the mobile device before deciding whether to proceed with the transaction. In some instances, the mobile device also may receive and display a similar picture-enhanced payment credential from the payment device, so that the user of the mobile device can likewise verify the identity of the person operating the payment device. In some additional instances, geolocation information also may be used to enhance transaction security by enabling the mobile device to detect the physical presence of the payment device, and vice versa.

By leveraging various aspects of these techniques and/or the other features and functionalities discussed in greater detail below, more robust, convenient, and secure payment functionalities can be provided to users of mobile devices.

Thus, in some embodiments discussed below, a computing device may authenticate a user of the computing device. Subsequently, the computing device may capture an image of the user, and further may store the image in a secure element. Then, responsive to receiving a request to provide a credential for a payment transaction, the computing device may cause the image from the secure element to be provided as the credential. In some instances, the image from the secure element may be provided as an identity credential for a payor in the transaction, while in other instances, the image from the secure element may be provided as an identity credential for a payee in the transaction.

In some other embodiments discussed below, a computing device may detect a payment device. Subsequently, the computing device may cause a payment credential to be displayed on the payment device, where the payment credential includes an image of an authorized user of the computing device. Thereafter, the computing device may receive, from the payment device, a request to complete a payment transaction. Responsive to receiving user input approving the payment transaction, the computing device may cause a payment to be made to an account associated with the payment device. In some embodiments, in receiving the request to complete the payment transaction, the computing device also may receive a photo credential for an authorized user of the payment device and/or an amount to be paid in the payment transaction, which can be displayed by the computing device.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented;

FIG. 1B illustrates another example operating environment in which various aspects of the disclosure may be implemented;

FIG. 2 illustrates an example of a payment credential that may be displayed by a computing device in one or more embodiments;

FIG. 3 illustrates an example of a data structure that may be used in storing a payment credential in one or more embodiments;

FIG. 4 illustrates another example of a payment credential that may be displayed by a computing device in one or more embodiments;

FIG. 5 illustrates a flowchart that depicts a method of defining a payment credential in one or more embodiments;

FIG. 6 illustrates a system that may utilize various aspects of the disclosure to facilitate a payment transaction in one or more embodiments;

FIG. 7 illustrates an example of a transaction being initiated based on the locations of various devices in one or more embodiments; and

FIG. 8 illustrates a flowchart that depicts a method of utilizing a payment credential to facilitate a payment transaction in one or more embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

As noted above, certain embodiments are discussed herein that relate to providing a picture-enhanced payment credential and using such a credential to facilitate payment processes. Before discussing these concepts in greater detail, however, an example of a computing device that can be used in implementing various aspects of the disclosure, as well as an example of an operating environment in which various embodiments can be implemented, will first be described with respect to FIGS. 1A and 1B.

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and so on) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail.

As introduced above, some aspects of the disclosure generally relate to providing a picture-enhanced payment credential that may be stored in a secure element, such as a software secure element, and that may be used in initiating and completing various financial transactions. Other aspects of the disclosure generally relate to payment processes in which the secure element may be accessed, and the picture-enhanced payment credential may be used, to complete a financial transaction. In the discussion below, a description of various examples of payment credentials will first be presented, followed by a description of various payment processes in which such payment credentials may be used.

FIG. 2 illustrates an example of a payment credential that may be displayed by a computing device in one or more embodiments. As seen in FIG. 2, a payment credential 200 may be displayed by a computing device (e.g., a mobile device, such as a smart phone, tablet computer, and/or the like) as part of a user interface or user interface element that is displayed and/or otherwise provided by the device. In one or more embodiments, a payment credential, such as payment credential 200, may include a picture 205 of an authorized user of the payment credential, a label 210 that includes information identifying the authorized user (e.g., such as the full name of the authorized user), and a listing 215 of one or more accounts that are linked to the payment credential. For example, listing 215 may include one or more account numbers, or portions of one or more account numbers, that may be credited or debited (as appropriate) when the payment credential 200 is used by the authorized user in one or more transactions.

In some embodiments, by displaying such a payment credential, a computing device may allow a user of the device to present his or her identifying information, along with his or her payment information, to another person or entity that is entering into a transaction with the user. These features may enable the other person or entity involved in the transaction to verify the identity of the user of the mobile device and confirm that the person using the mobile device is indeed an authorized user of the payment credential. For example, if the person using the mobile device (and attempting to use the payment credential) does not look like the person in the picture, then the other person or entity in the transaction might not want to proceed with completing the transaction, since the person using the mobile device might not be an authorized user of the payment credential (e.g., the device may be stolen or may be being used by someone who is not authorized to use the payment credential).

In some instances, a payment credential, such as payment credential 200, can be utilized by a user who is a payor in a transaction. For example, the payment credential may be used by a mobile device user in purchasing goods or services from a merchant in order to make a payment to the merchant for the purchased goods or services. In other instances, a payment credential, such as payment credential 200, can be utilized by a user who is a payee in a transaction. For example, the payment credential may be used by a mobile device user to accept a payment from a payor and enable the payor to verify that he or she is paying the individual, organization, or other entity that he or she intends to pay. These features may be particularly useful in cases where the person accepting the payment is doing so on behalf of an organization or other entity (e.g., a store clerk who is accepting payments on behalf of the store), as discussed in greater detail below with respect to the example illustrated in FIG. 4. Before turning to FIG. 4, however, an example of a data structure that may be used to store a payment credential will first be described.

FIG. 3 illustrates an example of a data structure that may be used in storing a payment credential in one or more embodiments. As seen in FIG. 3, a payment credential data structure 300 may include a number of different fields in which various pieces of information associated with the payment credential may be stored. Such a data structure may, for instance, be used to encapsulate and/or organize the information associated with a particular payment credential. In addition, such a data structure may be stored by a computing device, such as a mobile device, in a secure element.

In one or more embodiments, payment credential data structure 300 may include a user identifier field 305. Such a user ID field 305 may, for instance, store the name of the authorized user of the payment credential and/or other information that may be used in identifying the user (e.g., a user name that may be utilized by the user during a login or authentication process; a unique identifier, such as a unique string of alphanumeric characters; and/or the like).

In one or more embodiments, payment credential data structure 300 also may include a passcode field 310. Such a passcode field 310 may, for instance, store a passcode (e.g., a password, an access code, and/or the like) that can be used in unlocking, decrypting, and/or accessing the payment credential and/or information associated with the payment credential that is stored in the data structure 300. For example, in order to define, modify, and/or access a particular payment credential, a user may be required (e.g., by the mobile computing device accessing and/or storing the data structure 300) to enter and/or otherwise provide the passcode for authentication of the user.

In one or more embodiments, payment credential data structure 300 also may include an image data field 315. Such an image data field 315 may, for instance, store image data, such as image data that defines a picture of the authorized user of the payment credential.

In one or more embodiments, payment credential data structure 300 also may include an account identifier field 320. Such an account identifier field 320 may, for instance, store information about one or more accounts that are linked to the payment credential. This information may, for instance, include one or more account numbers for the one or more accounts that are linked to the payment credential, along with any other information that may be used in accessing and/or using these accounts (e.g., routing numbers, financial institution names, and/or the like). As illustrated in various examples discussed herein, when a payment credential is used in a transaction (e.g., in making or receiving a payment), funds may be debited from or credited to one or more of the accounts that are linked to the payment credential, as appropriate.

In some embodiments, payment credential data structure 300 also may include an additional information field 325 in which other types of information (which may, e.g., be needed and/or used in some circumstances where the payment credential is used) may be stored. For example, in some instances where the authorized user of a payment credential is an individual who has been designated to accept payments on behalf of another entity, such as a store clerk accepting payments on behalf of a store where he or she works, the additional information field 325 may store information that links the particular payment credential to the entity on behalf of which the authorized user is accepting payments. As discussed in greater detail with respect to some examples below, this information may include the name of the organization, image data that defines a badge or logo of the organization, and/or other information.

As indicated above, a particular instance of payment credential data structure 300, along with the information that it includes, may be stored in a secure element on a mobile device, where it can be encrypted, maintained, and securely accessed for use in payment transactions. In some instances, such a data structure may be stored in a software secure element, which may, for example, be an encrypted, password-protected file vault in which stored data is decryptable, accessible, and/or readable only upon authentication with appropriate login credentials. In other instances, such a data structure may be stored in a hardware secure element, such as an NFC (Near Field Communications) chip, a SIM (Subscriber Identity Module) card, and/or the like. In still other instances, a hardware secure element and a software secure element may be used in combination to store and control access to a payment credential data structure, such as payment credential data structure 300. For example, such a data structure may be stored in the software secure element, which might only be decryptable, accessible, and/or readable upon the computing device determining that a certain hardware secure element is connected to the device and/or otherwise present.

Before turning to a discussion of a method that may be performed in order to create, define, and/or modify a payment credential (e.g., payment credential 200, payment credential data structure 300, and/or the like), another example of a payment credential will first be described with respect to FIG. 4.

FIG. 4 illustrates another example of a payment credential 400 that may be displayed by a computing device in one or more embodiments. In particular, the example depicted in FIG. 4 illustrates how a payment credential, such as payment credential 400, may be displayed in circumstances where the authorized user of the payment credential (and/or the mobile device displaying the payment credential) is accepting, or has been designated to accept, payments on behalf of an organization or other entity. The authorized user of such a payment credential may, for instance, be a clerk in a retail store who can check out customers using his or her mobile device, a waiter in a restaurant who can settle checks using his or her mobile device, or any other person accepting payments on behalf of another person, organization, or entity. In some instances, such a user also may be operating a mobile device that has been configured (e.g., by the other person, organization, or entity for whom the user is accepting payments) to be used as a mobile point-of-sale terminal or other mobile payment device.

As seen in FIG. 4, payment credential 400, like payment credential 200, may include a picture 405 of the authorized user of the payment credential, a label 410 indicating the name of the authorized user, and a listing 415 of one or more accounts that are linked to the payment credential. In addition to these elements, payment credential 400 also may include several features which indicate that the payment credential is being used by the authorized user to accept payments (or otherwise transact) on behalf of another person, organization, or entity.

For example, payment credential 400 may include a badge or logo 420, and in some instances, such a badge or logo 420 may include or otherwise correspond to a logo or icon used by the person, organization, or entity for which the authorized user of the payment credential is accepting payments. Payment credential 400 also may, for example, include status text 425 which indicates that payments are being received on behalf of the other person, organization, or entity. These features may, for instance, enable another person who is transacting with the authorized user of the payment credential (e.g., a customer of the store, where the authorized user of the payment credential is a store clerk; a patron of the restaurant, where the authorized user of the payment credential is a waiter; and so on) to quickly and easily determine that the person using the payment credential 400 is, in fact, authorized to accept payments and/or conduct other transactions on behalf of the other person, organization, or entity (and that they are not, e.g., simply purporting to accept payments on behalf of the other person, organization, or entity while actually using a personal payment credential to deceitfully accept payments into a personal account). Thus, in an example where payment credential 400 is being used by a clerk at a retail store, logo 420 may include a logo of the store, and status text 425 may indicate that payments are being received by the clerk on behalf of the store. In another example where payment credential 400 is being used by a waiter at a restaurant, logo 420 may include a logo of the restaurant, and status text 425 may indicate that payments are being received by the waiter on behalf of the restaurant.

Having discussed several examples of a picture-enhanced payment credential, an example method that may be used to create, define, and/or modify such a payment credential will now be described with respect to FIG. 5.

FIG. 5 illustrates a flowchart that depicts a method of defining a payment credential in one or more embodiments. In some embodiments, the example method illustrated in FIG. 5 may be performed by a computing device, such as a mobile device (e.g., a smart phone, a tablet computer, a laptop computer, or other mobile computing device), which may, for instance, implement one or more aspects of computing device 101. In other embodiments, the example method illustrated in FIG. 5 may be embodied in computer-executable instructions that may, for instance, be stored in a computer-readable medium, such as a memory.

In one or more embodiments, the method illustrated in FIG. 5 may be performed in order to create, define, and/or modify a picture-enhanced payment credential that can be used with a particular mobile device. For example, a user of a mobile device may wish to create or modify a payment credential that links his or her mobile device (or his or her user account on the mobile device) to a particular financial account maintained with a financial institution. The example method illustrated in FIG. 5 may thus be initiated once such a mobile device receives user input (e.g., via a menu or other user interface) requesting that such a payment credential be created, defined, and/or modified. In other instances, the example method illustrated in FIG. 5 may be initiated by a mobile device based on a user of the device downloading, installing, and executing a certain software application on the mobile device, such as a mobile banking application provided by a financial institution (such as the financial institution that maintains the user's financial account).

As seen in FIG. 5, the method may begin in step 501, in which the current user of the mobile computing device may be authenticated. For example, the mobile device may, in step 501, prompt the user to enter a username or other account identifier associated with one or more financial accounts (such as the one or more financial accounts to which a payment credential has been, or is to be, linked), and may further prompt the user to provide a password or other access code that is associated with the one or more accounts. This authentication may, for instance, enable the mobile device to determine and confirm that the current user of the mobile device is, in fact, an authorized user of the one or more financial accounts. In addition, by authenticating the user in this way, unauthorized access to (and tampering with) the picture-enhanced payment credential that is created and/or stored on the mobile device may be prevented.

In some additional or alternative embodiments, instead of (or in addition to) asking the user to enter a user name and password, the mobile device also may prompt the current user of the device to provide biometric information, which can then be used by the mobile device in authenticating the user. Such biometric information may, for example, include a finger print that is collected using a finger print scanner included in and/or connected to the mobile device, a retinal scan that is captured using a camera included in and/or connected to the mobile device, and/or other biometric information sampled from the current user of the mobile device. The mobile device may, for instance, authenticate the user with this biometric information by comparing the sampled biometric information with previously registered biometric information for authorized users of the device and/or the payment credential.

Subsequently, in step 502, the mobile computing device may capture an image of the current user of the device. For example, the mobile device may capture such an image using a built-in camera. In other instances, the image might be captured using a connected scanner or by loading a previously captured and/or stored image. In some instances, capturing an image may include prompting the current user of the mobile device to take a picture of himself or herself. This prompting may provide the user with an amount of time to prepare for the picture (e.g., in which the user of the mobile device may place the device in a particular spot, position himself or herself, and wait for the conclusion of a countdown timer, at which point the device may take the picture).

In step 503, the mobile computing device may store the captured image in a secure element. For example, the mobile device may, in step 503, store the image that was captured in step 502 in a secure element by unlocking and accessing such a secure element and subsequently inserting the image data that defines the captured image into a payment credential data structure, such as payment credential data structure 300, which may already be stored in the secure element or which may be created (e.g., by the mobile device) in the secure element if it does not already exist. Additionally or alternatively, in storing the image, the mobile device may insert and/or modify other information in such a payment credential data structure based on the user authentication performed in step 501. This may, for instance, include inserting and/or updating the user's name, password, linked account numbers, and/or the like.

In some instances, the secure element in which the captured image (and the payment credential data structure) is stored may be a software secure element, which may include an encrypted and/or password-protected file vault that cannot be decrypted and/or accessed without the requested password and/or other access control credentials. In other instances, the secure element in which the captured image (and the payment credential data structure) is stored may be a hardware secure element, such as an NFC chip, a SIM card (e.g., a micro-SIM card, a nano-SIM card, and so on), or the like. In some instances in which a hardware secure element is used, the hardware secure element may be physically possessed by the authorized user of the payment credential, and may potentially be maintained and kept separately from the mobile device (except when being used, e.g., to access the payment credential data structure) in order to further enhance security in the event that the mobile device itself is lost or stolen.

In step 504, the mobile computing device may synchronize the captured image (which may also correspond to the image stored in the payment credential data structure) with a payment server. For example, the mobile device may establish a secure connection to a payment server (e.g., a server computer operated by a financial institution that may, for instance, maintain the one or more financial accounts to which the payment credential and associated picture are linked), authenticate with the server, and upload the captured image (and/or other information included in the payment credential data structure) via the secure connection. In some instances, in synchronizing the captured image with the payment server, the mobile device may send the entire payment credential data structure itself to the payment server. After receiving the captured image and/or other information from the mobile device, the payment server may then update its records and/or databases (e.g., to store copies of the captured image, the payment credential data structure, and/or other information received from the mobile device). As discussed in greater detail below, these records may subsequently be used by the payment server in facilitating one or more transactions in which the payment credential is used.

At this point in the execution of the example method illustrated in FIG. 5, the payment credential may have been created and/or updated, and further may have been synchronized with the payment server. As a result of this processing, the payment credential may, for instance, be displayed and/or used in initiating and/or completing a transaction.

For example, in step 505, the mobile device may determine whether a request to provide the payment credential has been received. For instance, the computing device may determine, in step 505, that the payment credential has been requested based on receiving user input that includes a request to perform a transaction with a payment device (e.g., using the payment credential).

As discussed above, the picture (and/or other information) stored in the secure element may, in some instances, be provided and used as a credential for a payor in a payment transaction. In other instances, this picture (and/or other information) may be provided and used as a credential for a payee in a transaction (e.g., instead of being used in sending money from a user of the mobile device to another person or entity, the picture-enhanced payment credential may be used by the user of the mobile device to receive money from another person or entity. In still other instances, a payment may be received by an authorized user of a payment credential (and an associated mobile device) on behalf of another person, organization, or entity, in which case the payment credential may include and/or be displayed with a badge or logo of the organization, in addition to including a displayable picture of the authorized user.

Thus, the mobile device may, in some embodiments, determine (e.g., in step 505) that the payment credential has been requested based on information received from another device, such as a payment device, which may have initiated (or may be attempting to initiate) a transaction with the mobile device. The information received from the other device (e.g., the payment device) may, for instance, be received by the mobile device via one or more messages and/or signals transmitted by the other device, and this information may include a request to initiate a transaction, a request for the payment credential and/or other information associated with the payment credential and/or the authorized user, and/or other information about the requested transaction (e.g., the proposed amount of the transaction, information about the person or entity requesting the transaction, and so on).

If it is determined (e.g., by the mobile device in step 505) that the payment credential has been requested, then in step 506, the mobile computing device may cause the image associated with the payment credential (e.g., the picture stored in the payment credential data structure), along with any of the other information associated with the payment credential (e.g., other information stored in the payment credential data structure), to be provided. Providing this image and/or other information may, in some embodiments, include displaying the image and/or the other information on the mobile device, and additionally or alternatively may include sending the image and/or the other information to a payment device, such as the payment device which may have requested the payment credential (e.g., in step 505). In some embodiments, providing this image and other information associated with the payment credential might not only include sending the image and this other information to such a payment device, but also may include causing the image and/or this other information to be displayed on the payment device.

In some instances where the request for the payment credential is received based on user input provided to the mobile device, the mobile device might not have preexisting information about which payment device should receive the payment credential (e.g., as it might not be clear which payment device the authorized user of the mobile device is attempting to transact with). In these instances, if there are a number of payment devices in the vicinity of the mobile device (e.g., within a predetermined distance of the mobile device, such as within ten feet or within range of a certain wireless signal, such as an NFC signal, a Bluetooth signal, or the like), the mobile device may determine which payment device to provide the payment credential to by determining which payment device is closest to the mobile device or which payment device(s) are within a shorter range of the mobile device (e.g., such as within five feet of the mobile device or within range of another, lower-power signal). This may, in some instances, result in the mobile device determining to provide, and subsequently providing, the payment credential to a number of payment devices, in which case various prompts and/or other user interfaces may be provided on the mobile device and/or the payment devices to allow the users of these devices to make various selections specifying which two devices are desired to be involved in the transaction. For example, these prompts and/or other user interfaces may be provided and/or used in a situation where the mobile device is being used in a large store, and a number of different payment devices (being operated by a number of different store employees) are close to and/or within a certain distance of the mobile device.

In some instances, causing the image to be displayed on the payment device may include retrieving the picture of the authorized user (and/or other information associated with the payment credential) from the secure element and sending the picture (and/or the other information) to the payment device. The mobile device may, for example, send the picture (and/or the other information) to the payment device via a direct connection between the devices (e.g., a directed wired or wireless connection from the mobile device to the payment device) or via an indirect connection between the devices, which may, for instance, be established across one or more networks. In some embodiments in which the computing device may extract the picture of the authorized user from the payment credential data structure and subsequently send it to the payment device, causing the picture to be displayed on the payment device may also include causing additional information about the user to be displayed on the payment device (e.g., the name of the authorized user, one or more linked account numbers, and/or the like). This additional information may, for instance, be obtained from the payment credential data structure.

In some other instances, causing the image to be displayed on the payment device may include sending a message to the payment device that causes and/or enables the payment device to download and/or receive the picture of the authorized user (and/or other information associated with the payment credential) from the payment server. For example, the mobile device may send a message to the payment device that includes user identification information for the authorized user (or other unique identifying information) that can be used by the payment device in requesting the picture (and/or the other information associated with the payment credential) from the payment server, which itself may have obtained this picture (and/or other information) during the synchronization performed in step 504. Such an arrangement may, for instance, provide increased transaction security because the image and other information that is displayed on the payment device and used for the transaction can be obtained directly from the financial institution that maintains the financial accounts to which the payment credential is linked, and the records maintained by the financial institution may be considered, in some instances, to be more secure and/or reliable than the information that is stored on the mobile device itself.

Additional details about how a picture-enhanced payment credential can be used in transactions are discussed in greater detail below in connection with FIGS. 6-8. In particular, having described various embodiments and examples in which, among other things, a picture-enhanced payment credential may be created, defined, updated, and/or maintained, several embodiments and examples will now be discussed in which, among other things, such a payment credential may be used to initiate and complete a transaction.

FIG. 6 illustrates a system that may utilize various aspects of the disclosure to facilitate a payment transaction in one or more embodiments. In particular, FIG. 6 depicts a system 600 that may include a number of servers, networks, and devices that may be involved in initiating and completing a payment transaction in some embodiments.

As seen in FIG. 6, system 600 may include a payment server 605, a network 610, a user mobile device 615, and a merchant payment device 620. In one or more embodiments, payment server 605 may communicate, via network 610, with both the user mobile device 615 and the merchant payment device 620. In addition, user mobile device 615 may store and/or otherwise maintain a payment credential that can be used by an authorized user of the device. For example, user mobile device 615 may execute one or more steps of the example method illustrated in FIG. 5 to create, define, and/or modify such a payment credential, which may incorporate one or more aspects of the various example payment credentials discussed above. In addition, in synchronizing such a payment credential, user mobile device 615 may, for instance, synchronize the payment credential with payment server 605 (e.g., by performing one or more steps of the example method discussed above with respect to FIG. 5, such as step 504). Additionally, payment server 605 may, for instance, be operated, controlled, and/or maintained by the same financial institution which maintains the one or more financial accounts to which the payment credential is linked.

In an example situation in which a payment transaction is initiated between the user mobile device 615 and the merchant payment device 620, both of these devices may communicate with payment server 605 (e.g., via network 610) in order to provide various functionalities that may be utilized in order to complete the transaction. For example, upon initiation of the transaction, merchant payment device 620 may communicate with payment server 605 to request and obtain a copy of a picture-enhanced payment credential for an authorized user of the mobile device 615. In addition, merchant payment device 620 may communicate with mobile device 615, via the payment server 605, to provide the mobile device 615 with information about the authorized user of the payment device 620 (such as a picture-enhanced payment credential for the person operating the payment device) and/or other information about the transaction, such as the amount of the transaction and details about the items or services being purchased. Furthermore, mobile device 615 may, for instance, communicate with payment server 605 (e.g., after a transaction request is received from the user of the mobile device or the payment device 620) to provide the payment server 605 with information indicating whether the transaction has been approved or denied by the user of the mobile device 615. This communication may, for instance, enable the payment server 605 to update various records and, if the transaction was approved, cause an appropriate amount of funds to be transferred (e.g., from a first account linked to the payment credential being used by the user of the mobile device 615 to a second account linked to the payment credential being used by the user of the payment device 620).

As illustrated in several examples discussed above, a payment transaction may, in some embodiments, be automatically initiated based on a number of factors, which may include whether the mobile device 615 and the payment device 620 are located within close proximity of each other (e.g., within a predetermined distance of each other). Additionally, in some embodiments, the payment server 605, which may be operated by a financial institution, may be located remotely from these devices, such as at a data center that is operated, controlled, and/or maintained by the financial institution. An example of a situation in which a payment transaction is initiated based on the proximity between a mobile device (e.g., mobile device 615) and a payment device (e.g., payment device 620) will now be discussed with respect to FIG. 7.

FIG. 7 illustrates an example of a transaction being initiated based on the locations of various devices in one or more embodiments. As seen in FIG. 7, one example in which a transaction may be initiated based on the locations of various devices (and in which other aspects of the disclosure can be utilized) is a situation in which a user of a mobile device (e.g., mobile device 615) and a user of a payment device (e.g., payment device 620) are physically near each other in a particular area. For instance, in the example depicted in FIG. 7, a number of devices, including user mobile device 615 and merchant payment device 620, may be located in a café area 700 of a restaurant. Additionally, in this example, user mobile device 615 may, for instance, be operated by a customer of the restaurant, and merchant payment device 620 may, for instance, be operated by a waiter who works for the restaurant. A number of other mobile devices 705 also may be located in the café area 700 of the restaurant, and these other mobile devices 705 may, for instance, be operated by other customers of the restaurant.

In this example, the user of mobile device 615, who may be a restaurant customer who is dining at the restaurant, may request his or her check from a waiter, who may be carrying payment device 620 in his or her pocket. The waiter may then bring the check to the customer or may display the check to the customer using his or her payment device 620, for example. The customer may wish to utilize a picture-enhanced payment credential linked to his or her mobile device 615 to pay the check. Thus, the user may, for instance, provide input to the mobile device 615 requesting that the payment credential be retrieved and displayed. Additionally or alternatively, mobile device 615 may detect the presence of payment device 620 and may automatically display the payment credential (or cause the payment credential to be displayed on the payment device 620) so that the payment credential can be used in completing the transaction.

For example, once the payment credential is displayed, the waiter may verify the identity of the customer (e.g., using the picture included in the picture-enhanced payment credential). In verifying the identity of the customer, the waiter may, for instance, determine and confirm that the person attempting to use the payment credential (e.g., the customer) matches the person in the picture (e.g., based on a comparison of the waiter's observations of the customer with the picture). In some instances, a payment credential for the waiter, such as payment credential 400, may also be displayed (e.g., on the customer's mobile device 615, on the waiter's payment device 620, and so on), so that the customer can similarly verify the identity of the waiter (and ensure that he or she is paying the restaurant, not the waiter individually).

Subsequently, mobile device 615 may receive a request to complete the transaction from payment device 620 (e.g., via a direct connection or signal, via a payment server, and/or via other means). Such a request may, in some instances, include information about the transaction, such as the total amount to be paid, the individual price(s) of purchased item(s), the amount of tax to be paid, the amount of gratuity to be paid, and so on. Then, mobile device 615 may prompt the user to provide input approving of or rejecting the transaction. If, for instance, the user rejects the transaction, then a notification may be generated (e.g., by mobile device 615) and sent to the payment device 620 and/or the payment server 605, to enable these devices to update records and/or respond appropriately. If, on the other hand, the user approves the transaction, then a different notification may be generated (e.g., by the mobile device 615) and sent to the payment device 620 and/or the payment server 605, again to allow these devices to respond appropriately. For example, based on receiving a notification approving the transaction, the payment server may cause an amount of funds (e.g., in accordance with the amount specified in the transaction) to be transferred from the customer's financial account to the restaurant's financial account. Some of the processing discussed in this example will now be described in greater detail with respect to FIG. 8.

FIG. 8 illustrates a flowchart that depicts a method of utilizing a payment credential to facilitate a payment transaction in one or more embodiments. In some embodiments, the example method illustrated in FIG. 8 may be performed by a computing device, such as a mobile device (e.g., a smart phone, a tablet computer, a laptop computer, or other mobile computing device), which may, for instance, include and/or implement one or more aspects of computing device 101. In other embodiments, the example method illustrated in FIG. 8 may be embodied in computer-executable instructions that may, for instance, be stored in a computer-readable medium, such as a memory.

In some embodiments, the example method illustrated in FIG. 8 may be performed in order to initiate and complete a payment transaction using a picture-enhanced payment credential, such as the payment credentials discussed in various examples above. The method may be initiated, for example, based on a user opening a software application (e.g., a mobile banking app) on his or her mobile device and issuing one or more commands via various user interfaces and/or menus that are provided as part of the software application. In other instances, the method may be initiated, for example, based on background processing performed by the mobile device and/or based on detected conditions (e.g., based on location information, based on detecting the presence of a nearby payment device, based on determining that the mobile device is located in a retail establishment which includes a payment device capable of processing payments using the payment credentials discussed above, and so on).

As seen in FIG. 8, the method may begin in step 801, in which the current user of the mobile computing device may be authenticated. For example, the mobile device may, in step 801, prompt the user to enter a username or other account identifier associated with one or more financial accounts (such as the one or more financial accounts to which a payment credential has been linked), and may further prompt the user to provide a password or other access code that is associated with the one or more accounts, similar to how a user can be authenticated in step 501. As above, this authentication may, for instance, enable the mobile device to determine and confirm that the current user of the mobile device is, in fact, an authorized user of the one or more financial accounts. In addition, by authenticating the user in this way, unauthorized access to (and tampering with) the picture-enhanced payment credential that is created and/or stored on the mobile device may be prevented.

Additionally or alternatively, authenticating the current user of the mobile device may, in some embodiments, be based on biometric information. For example, instead of (or in addition to) asking the user to enter a user name and password, the mobile device also may prompt the current user of the device to provide biometric information, which can then be used by the mobile device in authenticating the user. Such biometric information may, for example, include a finger print that is collected using a finger print scanner included in and/or connected to the mobile device, a retinal scan that is captured using a camera included in and/or connected to the mobile device, and/or other biometric information sampled from the current user of the mobile device. The mobile device may, for instance, authenticate the user with this biometric information by comparing the sampled biometric information with previously registered biometric information for authorized users of the device and/or the payment credential.

Subsequently, in step 802, the mobile computing device may detect a payment device. In some instances, detecting the payment device may include determining, based on location information that is determined and/or obtained by the mobile device, that the payment device is located within a predetermined distance of the computing device. This location information may, in some instances, include geolocation information (e.g., a street address; the name or the restaurant, store, or other place where the mobile device is being used; and/or the like; instead of simple geographic coordinates, for instance). In other instances, detecting the payment device may include receiving a wireless signal transmitted by the payment device. For example, in step 802, the mobile device may receive a signal transmitted by the detected payment device, such as an NFC signal, a Bluetooth signal, a wireless LAN (WLAN) signal, and/or any other type of signal.

In step 803, the mobile computing device may cause a payment credential to be provided to the payment device. In one or more embodiments, the payment credential that is caused to be provided (e.g., in step 803) may include a picture of the user who was authenticated in step 801. Such a picture may be have been captured and stored as part of the payment credential as a result of previous execution of the method discussed above with respect to FIG. 5. For example, the mobile device, in step 803, may provide a picture-enhanced payment credential, such as one of the picture-enhanced payment credentials discussed in the examples above (e.g., payment credential 200).

As illustrated in the examples above, the picture-enhanced payment credential (e.g., provided in step 803) may enable the other party in the payment transaction to verify that the person (who is operating the mobile device and its payment credential in an attempt to complete the transaction) is, in fact, the owner and/or an authorized user of the device and the payment credential (e.g., and can thus validly use the payment credential to complete a transaction in which funds may be debited or credited to a financial account linked to the payment credential and/or the mobile device). Thus, causing the payment credential to be provided to the payment device may, in some instances, include causing the picture and/or other information associated with the payment credential (e.g., stored in a payment credential data structure which corresponds to the payment credential) to be sent to and/or displayed on the payment device.

In some instances, causing the payment credential to be provided to the payment device may include causing the payment device to load (and subsequently display) the picture and/or other data associated with the payment credential from a central server. For instance, in the examples discussed above with respect to FIGS. 6 and 7, user mobile device 615 may cause merchant payment device 620 to load the picture and/or other data associated with the payment credential (namely, the payment credential being used by the authenticated user of mobile device 615) from the payment server 605. In some instances, such a central server (e.g., payment server 605) may be operated by a financial institution that maintains the accounts linked to the payment credential. Additionally or alternatively, such a central server may be the same server with which the mobile device may synchronize its payment credential information (e.g., in step 504 of the example method discussed above with respect to FIG. 5).

In other instances, causing the payment credential to be provided to the payment device may include retrieving the payment credential (and/or its underlying payment credential data structure) from a local secure element and subsequently sending information that is stored in and/or otherwise associated with the payment credential to the payment device. This information that is sent (e.g., by the mobile device) may, for instance, include the picture of the authorized user of the payment credential, user identification information, one or more account numbers that are linked to the payment credential, and/or the like. In addition, the payment credential may, for instance, be retrieved (e.g., by the mobile device) from a software secure element stored on the device, a hardware secure element included in the device, and/or combinations thereof.

In step 804, the mobile computing device may receive a request to complete a payment transaction. For example, the mobile device may, in some instances, receive such a request as a result of a user selection or other user input (e.g., received during execution of and/or via a mobile banking app). For instance, after detecting the payment device (e.g., in step 802) and causing the payment credential to be provided to the payment device (e.g., in step 803), the mobile device may provide one or more user interfaces and/or menus that enable the user to initiate a transaction with the payment device. These user interfaces and/or menus may, for instance, enable the user to define various aspects of the transaction, such as the amount of funds to be credited or debited in the transaction, the date and/or time to execute the transaction, and/or the like. Once the user has defined these and/or other aspects of the transaction, the user may issue a command to proceed with execution of the transaction, which may be received by the mobile device as the request to complete the transaction in step 804.

In other instances, after detecting the payment device (e.g., in step 802) and causing the payment credential to be provided to the payment device (e.g., in step 803), the mobile device may, in step 804, receive information from the payment device that includes a request to initiate and complete a transaction with the mobile device. In other words, the request received in step 804 (e.g., by the mobile device) may, in some instances, originate from the payment device. In addition, based on receiving such a request, the mobile device may display information about the requested transaction (e.g., based on the information received from the payment device) and additionally or alternatively may prompt the user of the mobile device to approve (or reject) the transaction (e.g., by providing appropriate user input).

In some instances, receiving a request to complete a payment transaction may include receiving a picture-enhanced payment credential for an authorized user of the payment device (also referred to as a “photo credential”) and subsequently displaying this credential. Such a picture-enhanced payment credential for a payee may, for example, be obtained directly from the payment device in some instances, while in other instances, such a payment credential may be obtained from a central server (e.g., payment server 605). In one example, the photo credential may be received in response to a request (e.g., sent by the mobile device) to the payment server for a picture-enhanced payment credential for the payee. As discussed above, in some instances, such a payment credential may be linked to an individual user's personal account, while in other instances, a payment credential may be linked to the account of another person, organization or entity, and the authorized user of the payment credential (e.g., whose picture may appear) may be an individual who is designated to receive payments on behalf of the other person, organization or entity. In these instances, in receiving and/or displaying the picture-enhanced payment credential for an authorized user of the payment device, the mobile device also may receive and/or display an image associated with the organization (e.g., a logo or badge) in addition to the image of the authorized user of the payment device (who may, for instance, be a store employee, a waiter, another designated person, and/or the like).

In some instances, receiving a request to complete a payment transaction may include receiving an amount to be paid by the authorized user of the mobile device in the payment transaction. In these instances, the amount (e.g., for the transaction) may also be displayed by the mobile device. This display may, for example, enable the user of the mobile device to decide if he or she wishes to approve the transaction, and this may also enable the user to confirm that the amount of the transaction is correct (and, e.g., in line with the user's dealing with the payee).

In step 805, the mobile computing device may determine whether the transaction has been approved. For example, the user may, in some instances, authorize the transaction after he or she verifies that he or she wishes to proceed with the transaction. This may include verifying that the other person in the transaction (e.g., the payee) matches the person shown in the photo credential associated with the payment device, in instances where such a photo credential was received by the mobile device (or, e.g., shown to the user of the mobile device on the payment device). Thus, in step 805, the mobile device may determine whether the transaction has been approved based on whether the mobile device has received user input approving of or rejecting the transaction. For example, the mobile device may determine that the transaction has been approved in response to receiving a selection of a “proceed/approve” button included in a prompt that may have been displayed by the mobile device (e.g., in step 804).

If the mobile computing device determines that the transaction has been approved (e.g., in step 805), then in step 806, the mobile computing device may cause a payment to be made to the one or more accounts linked with the payment device and/or the payment credential being used by the user of the payment device. Alternatively, in situations in which the user of the mobile device is receiving a payment from the other party in the transaction, the mobile device may cause the payment to be initiated to enable receipt of the funds. In some instances, in causing the payment to be made (or received), the computing device may, for example, communicate with one or more servers and/or devices operated by a financial institution, such as the payment server 605, to facilitate a transfer of the desired amount of funds.

Subsequently, in step 807, the mobile computing device may update one or more transaction history logs. For example, the mobile device may update its own records about proposed, accepted, and/or rejected transactions, and additionally or alternatively may provide information to other devices, including the payment device (e.g., payment device 620), the payment server (e.g., payment server 605), and/or other devices, so that these other devices can likewise update various records.

Thereafter, the method may end. In some instances, the method can be similarly reinitiated and executed by the mobile device at a later time, for instance, in completing another transaction with the same payment device or a different payment device, as may be desired by the user.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A computing device, comprising:
at least one processor; and
memory storing computer readable instructions that, when executed by the at least one processor, cause the computing device to:
detect a payment device;
cause a payment credential to be displayed on the payment device, wherein the payment credential includes an image of an authorized user of the computing device;
receive, from the payment device, a request to complete a payment transaction; and
responsive to receiving user input approving the payment transaction, cause a payment to be made to an account associated with the payment device.

2. The computing device of claim 1, wherein receiving the request to complete the payment transaction includes:
receiving a photo credential for an authorized user of the payment device; and
displaying the photo credential for the authorized user of the payment device.

3. The computing device of claim 1, wherein receiving the request to complete the payment transaction includes:
receiving an amount to be paid by the authorized user in the payment transaction; and
displaying the amount.

4. The computing device of claim 1, wherein detecting the payment device includes determining, based on location information, that the payment device is located within a predetermined distance of the computing device.

5. The computing device of claim 1, wherein detecting the payment device includes receiving a wireless signal transmitted by the payment device.

6. The computing device of claim 1, wherein causing the payment credential to be displayed on the payment device includes causing the payment device to load the image of the payment credential from a central server.

7. The computing device of claim 1, wherein causing the payment credential to be displayed on the payment device includes:
retrieving the payment credential from a local secure element; and
sending the payment credential to the payment device.

8. A method, comprising:
detecting, by a computing device, a payment device;
causing, by the computing device, a payment credential to be displayed on the payment device, wherein the payment credential includes an image of an authorized user of the computing device;
receiving, by the computing device, from the payment device, a request to complete a payment transaction; and
responsive to receiving user input approving the payment transaction, causing, by the computing device, a payment to be made to an account associated with the payment device.

9. The method of claim 8, wherein receiving the request to complete the payment transaction includes:
receiving a photo credential for an authorized user of the payment device; and
displaying the photo credential for the authorized user of the payment device.

10. The method of claim 8, wherein receiving the request to complete the payment transaction includes:
receiving an amount to be paid by the authorized user in the payment transaction; and
displaying the amount.

11. The method of claim 8, wherein detecting the payment device includes determining, based on location information, that the payment device is located within a predetermined distance of the computing device.

12. The method of claim 8, wherein detecting the payment device includes receiving a wireless signal transmitted by the payment device.

13. The method of claim 8, wherein causing the payment credential to be displayed on the payment device includes causing the payment device to load the image of the payment credential from a central server.

14. The method of claim 8, wherein causing the payment credential to be displayed on the payment device includes:
retrieving the payment credential from a local secure element; and
sending the payment credential to the payment device.

15. One or more non-transitory computer-readable media having instructions stored thereon that, when executed by a computing device, cause the computing device to:
detect a payment device;
cause a payment credential to be displayed on the payment device, wherein the payment credential includes an image of an authorized user of the computing device;
receive, from the payment device, a request to complete a payment transaction; and
responsive to receiving user input approving the payment transaction, cause a payment to be made to an account associated with the payment device.

16. The one or more non-transitory computer-readable media of claim 15, wherein receiving the request to complete the payment transaction includes:
receiving a photo credential for an authorized user of the payment device; and
displaying the photo credential for the authorized user of the payment device.

17. The one or more non-transitory computer-readable media of claim 15, wherein receiving the request to complete the payment transaction includes:
receiving an amount to be paid by the authorized user in the payment transaction; and
displaying the amount.

18. The one or more non-transitory computer-readable media of claim 15, wherein detecting the payment device includes determining, based on location information, that the payment device is located within a predetermined distance of the computing device.

19. The one or more non-transitory computer-readable media of claim 15, wherein detecting the payment device includes receiving a wireless signal transmitted by the payment device.

20. The one or more non-transitory computer-readable media of claim 15, wherein causing the payment credential to be displayed on the payment device includes causing the payment device to load the image of the payment credential from a central server.

21. The one or more non-transitory computer-readable media of claim 15, wherein causing the payment credential to be displayed on the payment device includes:
retrieving the payment credential from a local secure element; and
sending the payment credential to the payment device.
